(19) United States
(12) Patent Application Publication
(10) Pub. No.: US 2008/0016105 A1
(43) Pub. Date: Jan. 17, 2008

(54) System for annotating digital images within a wiki environment over the world wide web

(75) Inventors: Stephen J. Freeland, Catonsville, MD (US); Robin I. Farabaugh, Catonsville, MD (US); Philip J. Farabaugh, Catonsville, MD (US)

Correspondence Address: WENDY C. MARTIN;UMBC OTD, Suite 310, 5523 Research Park Drive, Baltimore, MD, 21228, US

(73) Assignee: UNIVERSITY OF MARYLAND, BALTIMORE COUNTY, Baltimore, MD (US)

(21) Appl. No.: 11/820,395

(22) Filed: Jun. 19, 2007

Related U.S. Application Data
(60) Provisional application No. 60/814,849, filed on Jun. 19, 2006.

(51) Int. Cl. G06F 17/30

(52) U.S. Cl. 707/102; 707/E17.044

(57) ABSTRACT

We present a method and instruction set, stored in a computer-readable medium, to annotate digitized images of text and/or graphics within a hypermedia “Wiki” environment for delivery across the world wide web. The method and instruction set comprise (1) a defined data structure for the digitized image object and associated metadata; (2) a three-piece integrated system for creating/editing these digital objects, viewing these digital objects and incorporating these objects into a wiki page.

### CROSS REFERENCE TO RELATED APPLICATIONS

This application is entitled to, and claims the benefit of priority from, U.S. Provisional Application Ser. No. 60/814,849 filed on Jun. 19, 2006

### BACKGROUND OF THE INVENTION

Academic, governmental and commercial environments work increasingly with digital documents. Here and throughout this document we refer to “document” in the broadest sense: this might be a “text” document, a photograph, a graphical diagram or any other semiotic image that can be rasterized and thus represented on a computer in a manner that is readable by a human user. Such work divides conceptually into two types of digital information. On the one hand, there exist reference materials that are ‘inert’ (in the sense that each is a static object forming the background to a discussion and or revisions); examples of such ‘inert’ reference documents are: an academic research paper, a policy document, a business plan, a digitized photograph etc.). On the other hand, there exist ‘dynamic annotations’ to this document; examples of such dynamic annotations include: comments, suggested changes, links to related material and other associated metadata pertaining to the inert material).

We propose here to deliver a software system that would combine these two types of information into a single digital data object that can be created, viewed and edited either “stand alone” or over the internet. We further propose to create an interface that will allow the incorporation of such annotated documents into a wiki. A wiki is a collection of hypertext web-pages, each of which can be visited and edited by any member of a distributed user-base (see glossary). As such, the interface that we propose to create between annotation and wiki will enable an appropriate user-base to construct a large, standing body of hyperlinked information that forms a natural context for multiple discussions of thematically related documents.

### SUMMARY OF THE INVENTION

The system we propose has three interconnected applications, and a data structure that represents the digital information to be created, edited and displayed by these applications. An overview of this system is presented in FIG. 1. The three interdependent components are as follows:

Annotation Object Generator: this component permits users to create digital data objects that that will be displayed and edited by the two components described below.

Annotation Object Viewer/Editor: this component permits users to view the data objects created by the Annotation Object Generator, and to add, remove or edit the annotations contained therein.

Annotation Object Wiki Plug-in: this component allows digital data objects of the type produced by the Annotation Object Generator to be incorporated into a wiki environment, such that each annotation links into the body of information contained within a wiki.

### BRIEF DESCRIPTION OF DRAWINGS

The foregoing and still other objects of this invention will become apparent, along with various advantages and features of novelty residing in the present embodiments, from study of the following drawings, in which:

FIG. 1 illustrates the overall flow of control in our system, including the connections between the three specific components;

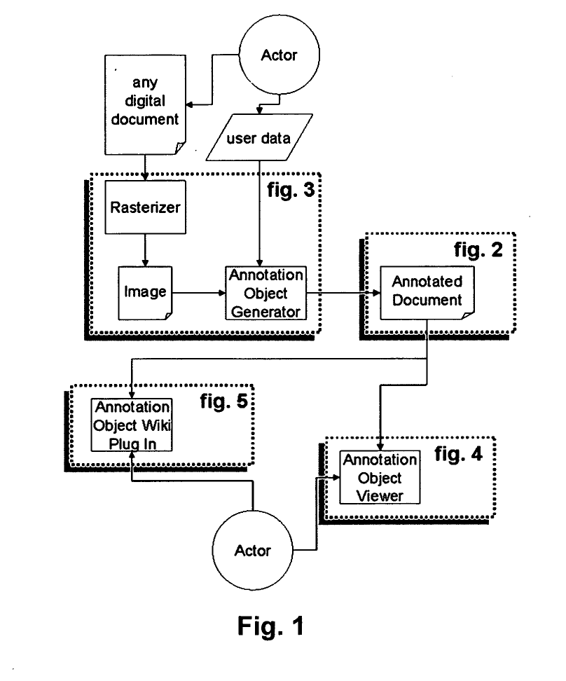

FIG. 2 illustrates the data structure that lies at the heart of the proposed system (each annotated document would be stored electronically in the form of this data structure);

FIG. 3 illustrates the system specifications for the component that creates annotation objects (i.e. combines digital document with annotations and associated metadata into an instance of the data structure illustrated in FIG. 2);

FIG. 4 illustrates the system specifications for the component that allows users to view instances of annotated documents (and edit annotations) through a standard web-browser;

FIG. 5 illustrates the system specifications for the component that allows users to insert instances of the annotated documents into a standard wiki.

FIG. 6 gives a simplified graphical illustration of how the finished product might appear within a web-browser window.

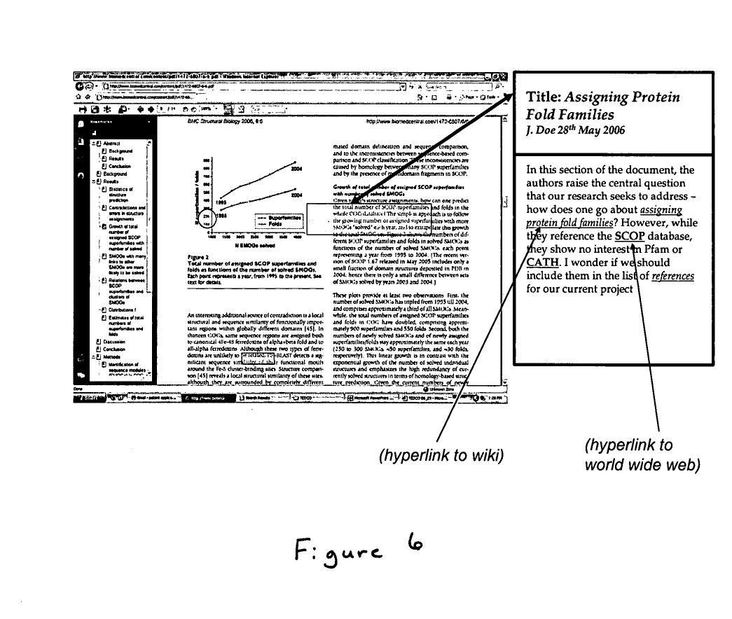

### DETAILED DESCRIPTION OF THE INVENTION

What follows is a detailed description, including System Requirement Specifications, for the computer-readable method and instruction set that we propose.

### Example 1

### The Annotation Object Data Structure

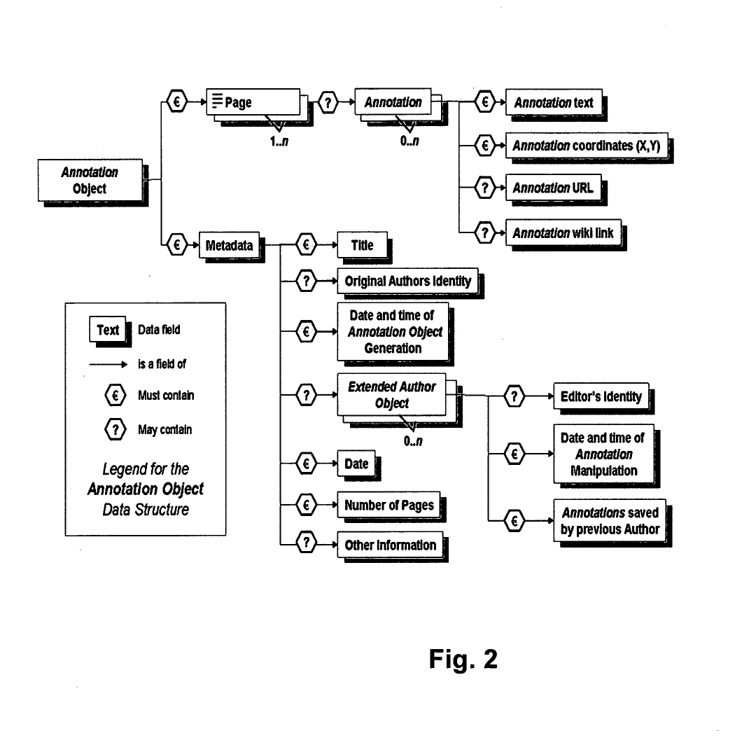

The conceptual foundation for our method and instruction set is a digital data object to be known hereafter as the “annotation object”. The logical structure of the annotation object is illustrated in FIG. 2. The data object comprises a rasterized image of a document itself comprising one or many pages. Each of these pages is associated with one or many annotations. Each annotation is associated with Cartesian coordinates that locate its physical position in terms of the bottom left corner of the annotation on the page, the size of the annotation (as it extends, right and up from this coordinate corner), and a unique identifier or primary key for that comment. Aside from these data items (rasterized pages and associated comments), each annotation object is associated with descriptive data including its title, the number of pages that it comprises, the author, the time and date of creation, the original source for the document and auxiliary textual information.

### Example 2

### The Annotation Object Generator

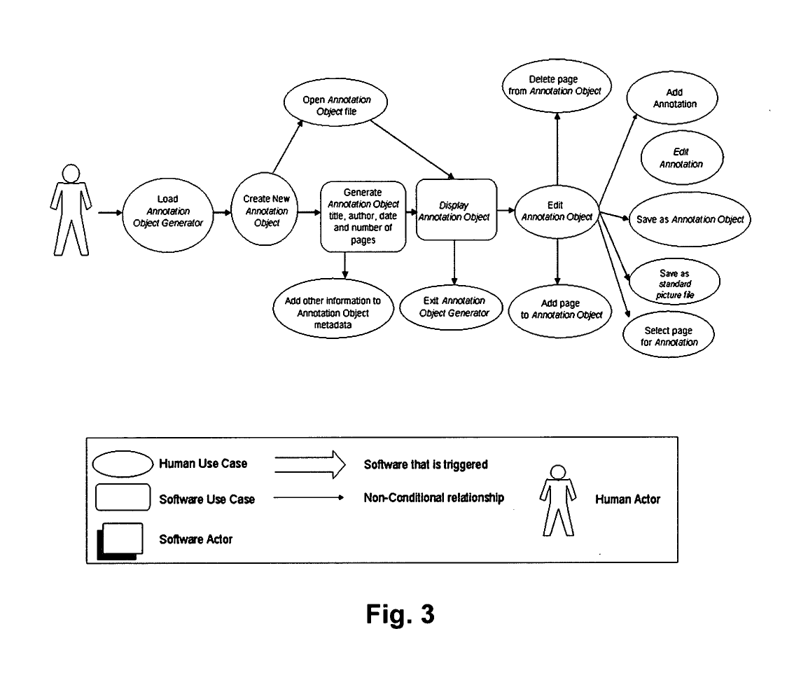

We propose a computer-readable method and instruction set that will produce and manipulate instances of the annotation object described above (3a). We refer to this method and instruction set hereafter as the Annotation Object Generator. The Annotation Object Generator will allow users to open and display existing instances of the annotation object, create new instances of this object, edit data fields of this object, and save instances of this data object. The Annotation Object Generator is illustrated in FIG. 3.

### Example 3

### The Annotation Object Viewer

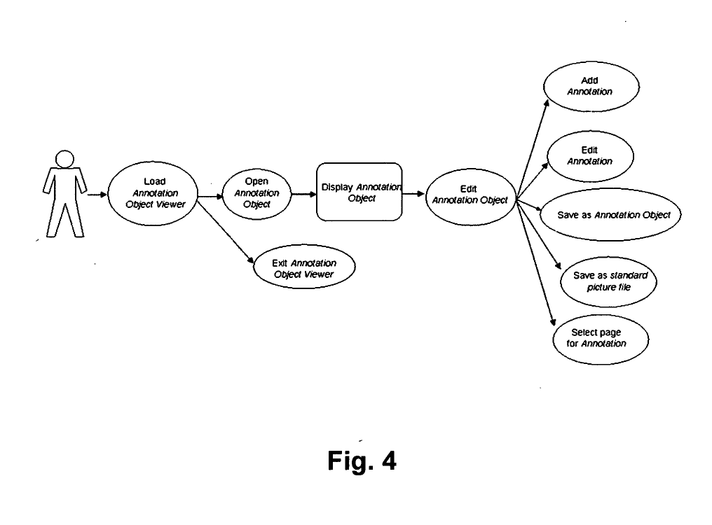

We propose a computer-readable method and instruction set that will allow users to view pre-existing instances of the annotation data object (described EXAMPLE 1, generated EXAMPLE 2) within a web-browser environment. This viewer will allow users to create, remove and edit comments associated with pages of the annotation data object, but will not allow users to alter any other fields of the object. Anyone who edits an annotation after its creation is considered an extended author and the annotation object will be aware of each change made by an extended author. The Annotation Object Viewer is illustrated in FIG. 4.

### Example 4

### The Annotation Object Wiki Plug-In

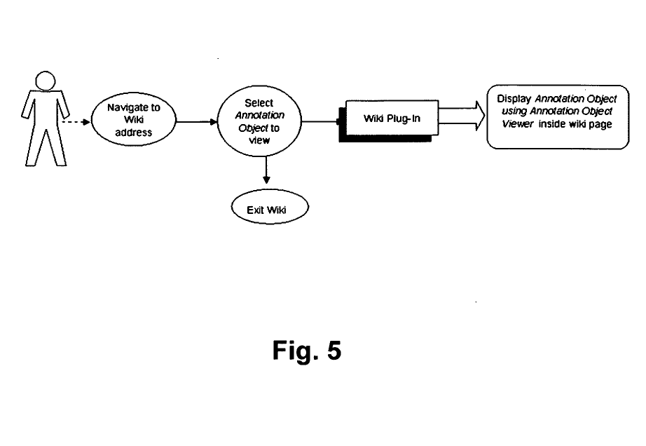

We propose a computer-readable method and instruction set that will allow users to integrate instances of the data object (described 3a, generated 3b, viewed/edited 3c) into a wiki environment, such that users may hyperlink specific annotations on specific pages of the annotation data object to specific wiki pages. The Annotation Object Wiki Plug-in software is illustrated in FIG. 5.

Thus, there has been described a novel system for annotating digital images within a wiki environment over the world wide web and a manner of making and using the invention.

While specific embodiments of the invention have been shown and described in detail to illustrate the application of the principles of the invention, it will be understood that the invention may be embodied otherwise without departing from such principles and that various modifications, alternate constructions, and equivalents will occur to those skilled in the art given the benefit of this disclosure. Thus, the invention is not limited to the specific embodiment described herein, but is defined by the appended claims.

Glossary of Terms

The following supplemental section of this document defines specific terms that may be ambiguous and/or necessary for the reader's complete understanding and comprehension of this provisional patent application.

An annotation is both the visual highlighting of a certain area of a standard picture file or as well as some text, with or without embedded hyperlinks, that reflects an idea, comment, or opinion linked to the visually highlighted area. The annotation is the manifestation of the data object described in section 2.1.

A compatible web browser is a browser such as Internet Explorer 5.5+, Netscape 6+, Mozilla based browsers. And with appropriate configuration:
Lynx if Unicode UTF-8 character set is selected in options. Proper display may require setting your terminal for Unicode.
Links if in graphics mode.

An extended author object is a data structure that holds information about someone who uses the annotation object viewer and to modify the annotation object.

A standard picture file is a digitally rasterized image of any semiotic information: for example, a page of a word-processed or hand-written document, a photograph, a graphical construct or a scanned image.

A wiki is a collection of text-based pages, interconnected through hyperlinks that may be viewed and edited over the internet. The most famous example of a wiki to date is WikiPedia (http://www.wikipedia.org/) in which a vast collection of such pages form a freely accessible, online encyclopedia.

What is claimed is:

1. A method for annotating digital images within a wiki environment over the world wide web comprising the steps of;
a) rasterizing a digital image into a uniform file format of a plurality of pages; and
b) associating descriptive metadata with the file; and
c) organizing the said files into a hierarchical system of pages to form projects; and
d) associating each said project with an instance of a wiki; and
e) using an editable web-browser interface to view any level of said project; and
f) editing said project within said web-browser interface to create additional wiki pages.
